(19) United States
(12) Patent Application Publication
(10) Pub. No.: US 2023/0377043 A1
(43) Pub. Date: Nov. 23, 2023

(54) METHODS AND SYSTEMS FOR INVESTMENT SCORING AND RANKING

(71) Applicant: KOHLBERG KRAVIS ROBERTS & CO. L.P., New York, NY (US)

(72) Inventors: Emil WERR, Wayne, NJ (US); Daniel SANDHOLDT, Kalispell, MT (US); Xiaocong LIU, Dix Hills, NY (US); Andrew MATANGAIDZE, Emeryville, CA (US)

(73) Assignee: KOHLBERG KRAVIS ROBERTS & CO. L.P., New York, NY (US)

(21) Appl. No.: 17/747,059

(22) Filed: May 18, 2022

(51) Int. Cl. G06Q 40/06; G06K 9/62; G06N 20/00

(52) U.S. Cl. CPC G06Q 40/06; G06K 9/6267; G06N 20/00

(57) ABSTRACT

A method, system, and computer program product for investment scoring and ranking may include a computing device storing data and an investment score of one or more entities and extracting one or more features from the data. The computing device may generate one or more rules including one or more records corresponding to a feature and each of the one or more records defining at least a weight for the corresponding feature such that each feature represents a maximum percentage of a score. The computing device may receive data regarding a new entity, extract one or more features from the data regarding the new entity and apply the one or more rules corresponding to the one or more features of the data. The computing device may output a new investment score for the new entity based on the one or more rules indicating an investment potential of the new entity.

### FIELD

The present disclosure relates to methods, systems, and computer program products for investment scoring and ranking. More particularly, the present disclosure relates to analyzing data related to one or more entities to generate an investment score and rank for an entity indicating an investment potential for the entity.

### BACKGROUND

Financial analysts evaluate businesses to determine and identify investment opportunities for their clients and/or employers. Currently, financial analysts must manually analyze data related to businesses to determine investment opportunities in those businesses. For example, a financial analyst can look for macroeconomic opportunities, such as high-performing sectors, and then identify the best companies within that sector by analyzing the stocks of specific companies to choose potentially successful ones as investments. Alternatively, a financial analysis may identify a specific business and analyze past business performance and expected future business performance as investment indicators. However, these manual data analysis approaches require a financial analyst to identify and analyze enormous amounts of data such as business financial data, business employment data, web traffic data, business sector data, or any other company fundamental data, etc. Thus, there is a need for a novel solution to more efficiently and effectively analyze entities to identify potential investment opportunities.

### SUMMARY

A method for investment scoring and ranking is disclosed. The method includes storing, in a memory of a processing device, data and an investment score of one or more entities; extracting, by the processing device, one or more features from the data; generating, by the processing device, one or more rules, the one or more rules including one or more records, each of the one or more records corresponding to a feature and each of the one or more records defining at least a weight for the corresponding feature such that each feature represents a maximum percentage of a score; receiving data regarding a new entity; extracting, by the processing device, one or more features from the data regarding the new entity; applying, by the processing device, the one or more rules corresponding to the one or more features of the data regarding the new entity; and outputting, by the processing device, a new investment score for the new entity based on the one or more rules, the new investment score indicating an investment potential of the new entity.

A system for investment scoring and ranking is disclosed. The system including one or more processors, one or more computer-readable memories, one or more computer-readable tangible storage devices, and instructions stored on at least one of the one or more storage devices for execution by at least one of the one or more processors via at least one of the one or more computer-readable memories, the instructions comprising: instructions to store data and an investment score of one or more entities; instructions to extract one or more features from the data; instructions to generate one or more rules, the one or more rules including one or more records, each of the one or more records corresponding to a feature and each of the one or more records defining at least a weight for the corresponding feature such that each feature represents a maximum percentage of a score; instructions to receive data regarding a new entity; instructions to extract one or more features from the data regarding the new entity; instructions to apply the one or more rules corresponding to the one or more features of the data regarding the new entity; and instructions to output a new investment score for the new entity based on the one or more rules, the new investment score indicating an investment potential of the new entity.

A computer program product for investment scoring and ranking is disclosed. The computer program product including: a computer-readable storage medium having program instructions embodied therewith, the program instructions executable by a computer to cause the computer to perform a method, comprising: storing, in a memory of a processing device, data and an investment score of one or more entities; extracting, by the processing device, one or more features from the data; generating, by the processing device, one or more rules, the one or more rules including one or more records, each of the one or more records corresponding to a feature and each of the one or more records defining at least a weight for the corresponding feature such that each feature represents a maximum percentage of a score; receiving data regarding a new entity; extracting, by the processing device, one or more features from the data regarding the new entity; applying, by the processing device, the one or more rules corresponding to the one or more features of the data regarding the new entity; and outputting, by the processing device, a new investment score for the new entity based on the one or more rules, the new investment score indicating an investment potential of the new entity.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 illustrates a high-level system architecture for investment scoring and ranking in accordance with exemplary embodiments;

FIGS. 2A-2B is a flow chart illustrating a process for investment scoring and ranking in accordance with exemplary embodiments;

FIG. 3 is a flowchart illustrating a method for investment scoring and ranking in accordance with exemplary embodiments; and

FIG. 4 is a block diagram illustrating a computer system architecture in accordance with exemplary embodiments.

### DETAILED DESCRIPTION

As discussed above, current methods of entity data analysis performed by financial analysts require extensive manual analysis of massive amounts of data. Thus, current financial analysis methods are inefficient and prone to user error. Exemplary embodiments of the methods and systems provided herein address the issues with the current methods by reducing the manual effort in data analysis and research for the identification of companies with higher probability of returns on equity and for the selection of companies for private equity fund composition. In particular, exemplary embodiments of the methods and systems provide algorithms/engines, e.g., rules, to automate the selection of attributes from data and weights given to those attributes that are used in an investment analysis. Thus, exemplary embodiments of the methods and systems provided herein provide a more efficient method to identify deal sourcing opportunities.

### System Overview for Investment Scoring and Ranking

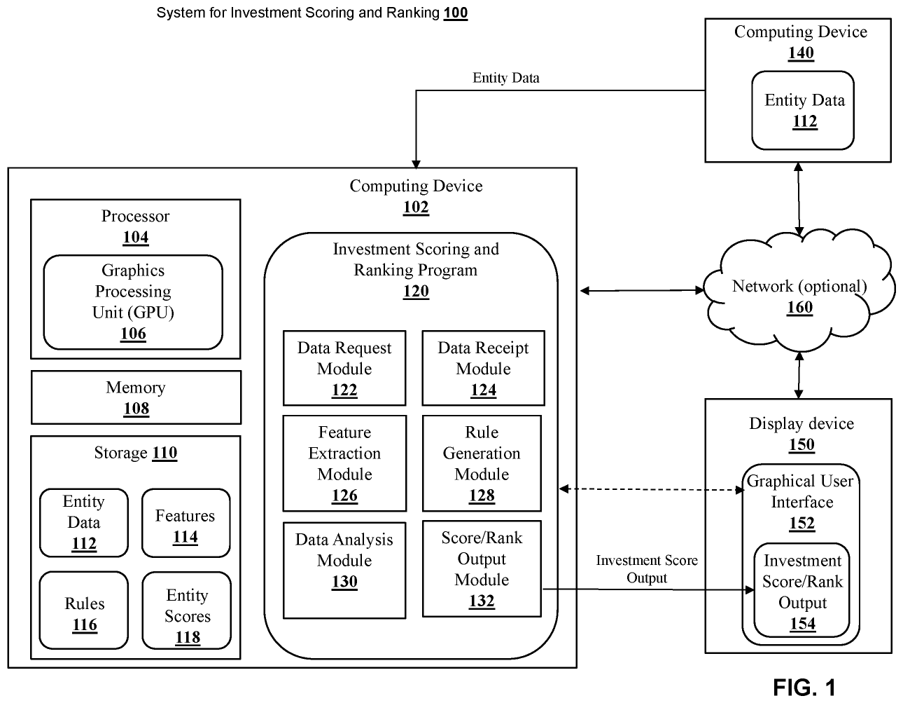

FIG. 1 illustrates system 100 for investment scoring and ranking in accordance with exemplary embodiments.

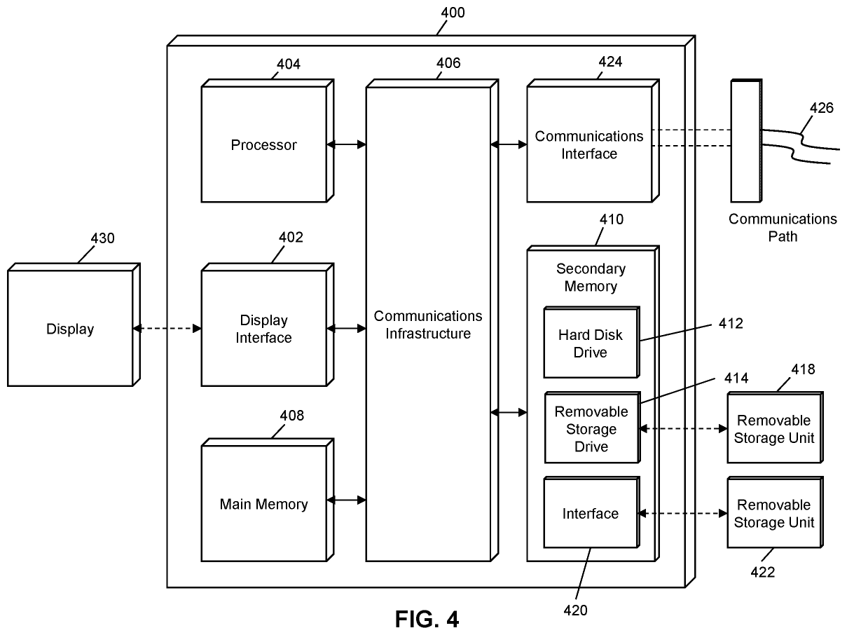

The computing device 102 includes, for example, a processor 104, a memory 108, a storage 110, and an investment scoring and ranking program 120. The device 102 may be a desktop computer, a notebook, a laptop computer, a tablet computer, a handheld device, a smart-phone, a thin client, or any other electronic device or computing system capable of storing, compiling, and organizing audio, visual, or textual data and receiving and transmitting that data to and from other computing devices, such as the computing device 140, and/or the display device 150. For example, the computer system 400 illustrated in FIG. 4 and discussed in more detail below may be a suitable configuration of the computing device 102. While only a single computing device 102 is illustrated, it can be appreciated that any number of computing devices 102 can be a part of the system 100.

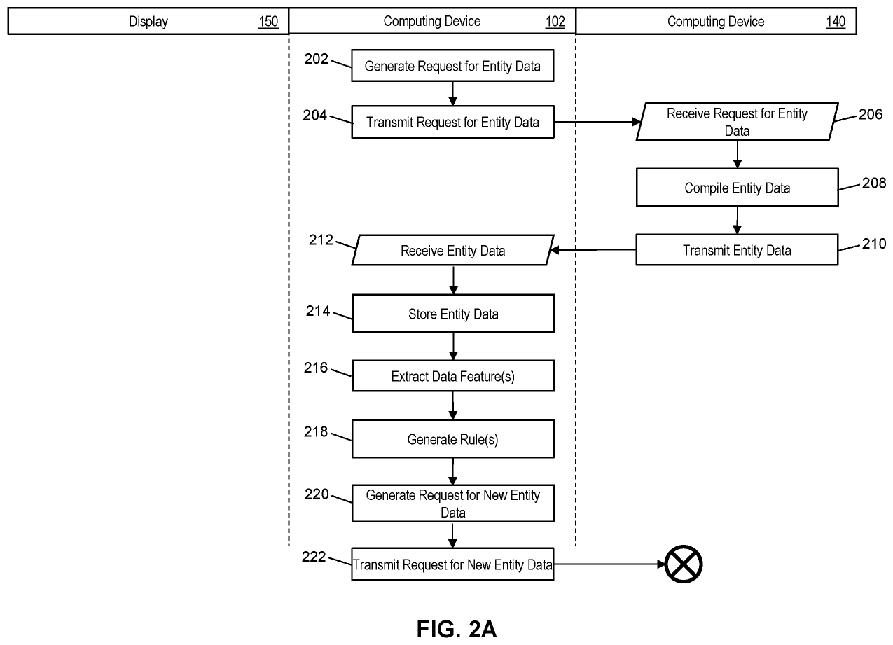

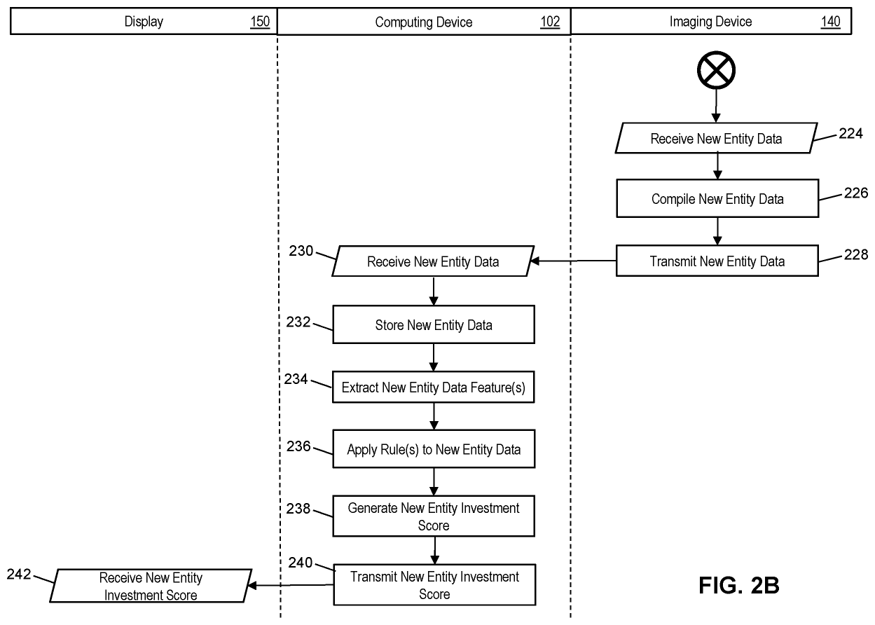

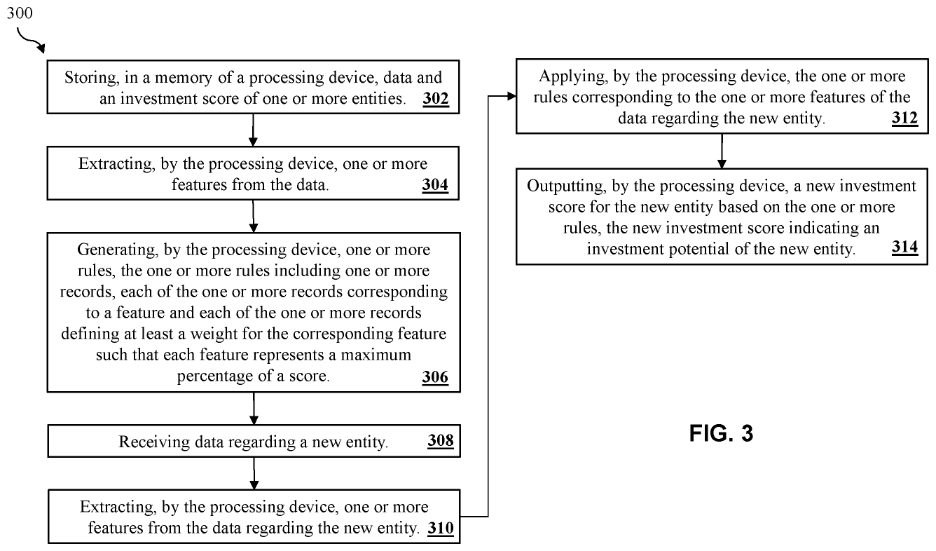

The processor 104 may include a graphics processing unit (GPU) 106. The processor 104 may be a special purpose or general purpose processor device specifically configured to perform the functions discussed herein. The processor 104 unit or device as discussed herein may be a single processor, a plurality of processors, or combinations thereof. Processor devices may have one or more processor “cores.” In an exemplary embodiment, the processor 104 is configured to perform the functions associated with the modules of the investment scoring and ranking program 120 as discussed below with reference to FIGS. 2A, 2B, and 3. The GPU 106 may be specially configured to perform the functions of the investment scoring and ranking program 120 discussed herein. For example, the GPU 106 is configured to process and/or generate graphics associated with the entity data 112 and/or the investment scoring and ranking program 120 such as, but not limited to, the entity score 118 and the investment score and rank output 154.

The memory 108 can be a random access memory, read-only memory, or any other known memory configurations. Further, the memory 108 can include one or more additional memories including the storage 110 in some embodiments. The memory 108 and the one or more additional memories can be read from and/or written to in a well-known manner. In an embodiment, the memory and the one or more additional memories can be non-transitory computer readable recording media. Memory semiconductors (e.g., DRAMs, etc.) can be means for providing software to the computing device such as the investment scoring and ranking program 120. Computer programs, e.g., computer control logic, can be stored in the memory 108.

The storage 110 can include, for example, entity data 112, one or more features 114, rules 116, and entity scores 118. The storage 110 can be deployed on one or more nodes, e.g., storage or memory nodes, or one or more processing-capable nodes such as a server computer, desktop computer, notebook computer, laptop computer, tablet computer, handheld device, smart-phone, thin client, or any other electronic device or computing system capable of storing, compiling, and/or processing data and computer instructions (e.g., entity data 112, features 114, rules 116, and entity scores 118, etc.), and receiving and sending that data to and from other devices, such as the computing device 140, and/or the display device 150. The storage 110 can be any suitable storage configuration, such as, but not limited to, a relational database, a structured query language (SQL) database, a distributed database, or an object database, etc. Suitable configurations and storage types will be apparent to persons having skill in the relevant art.

The entity data 112 may be any data regarding an entity such as, but not limited to, a corporation, a company, a partnership, a sole proprietorship, or any other business entity. In an exemplary embodiment, the entity is any business entity capable of being invested in. The entity data 112 includes, but is not limited to, web traffic information (e.g. number of daily visitors to a website operated by or otherwise associated with the entity), employment information (e.g., a number of employees, employee statistical information, employee educational information, employee titles, etc.), founders information (e.g., education background, business background, etc.), and corporate fundamentals (e.g., entity growth rate, entity revenue, entity profit, entity stock price, etc.), etc. The entity data 112 may be, but is not limited to, textual data, image data, audio data, video data, or a database, etc. received and/or collected from one or more sources (e.g., the computing device 140). The entity data 112 may be received in any suitable format such as, but not limited to, XML, CSV, TAB, PDF, HTML, plain text, TIFF, JPEG 2000, PNG, JPEG/JFIF, DNG, BMP, GIF, MOV, MPEG-4, AVI, MXF, etc. The entity data 112 includes raw data (e.g. data as it is received from computing device 140) and derived data (e.g. data that is generated based on the raw data). For example, raw data may be a geographic location of an entity and derived data may be a percent growth of the entity calculated using yearly revenue of the entity or employee numbers of the entity. The entity data 112 may be received by the computing device 102 from the computing device 140 and stored in the storage 110. The investment scoring and ranking program 120 generates one or more features 114 based on the entity data 112. The one or more features 114 include, but are not limited to, a growth rate, a percentage change over one or more periods, a ratio, or any other determinable statistic that can be generated from the entity data 112. For example, the entity data 112 may include a monthly employee count for an entity and the computing device 102 can generate a feature 114 of month to month change in employment for the company (e.g., a change in number of employees over a six-month period). As a further example, the entity data 112 may include employee titles for an entity and the investment scoring and ranking program 120 can generate a feature 114 of employee type ratio (e.g., a ratio of engineers to total employee count, a ratio of executives to other employees, etc.). The investment scoring and ranking program 120 may generate the one or more features 114 automatically or on-demand as needed by the investment scoring and ranking program 120 and/or as entity data 112 is received by the computing device 102. The investment scoring and ranking program 120 may classify the one or more features 114 into one or more feature categories such as, but not limited to, employee data, web traffic data, entity financial data, etc. The investment scoring and ranking program 120 may join similar features 114 from multiple data sources (e.g., a plurality of computing devices 140) so the investment scoring and ranking program 120 only has to look at one data source (e.g., a single computing device 140) for a feature 114. The one or more features 114 may be stored as virtual datasets in the storage 110 or in any other suitable storage configuration.

The rules 116 utilize the entity data 112 as input and output an entity score 118 based on one or more parameters. For example, an entity score 118 may be a value from one to one hundred with a high score indicating a high likelihood of success with a high investment recommendation or a low score indicating a low likelihood of success with a low investment recommendation, etc. Further, each of the entities may be ranked using the entity scores 118. For example, the investment scoring and ranking program 120 may evaluate five entities, as discussed below based on applying the rules 116 to the entity data 112 associated with each entity, and those five entities may be ranked against each other and any other entity previously evaluated by the investment scoring and ranking program 120. Each of the rules 116 may include one or more of the features 114 with one or more parameters for each feature 114. The one or more parameters include, but are not limited to, a threshold value (e.g., a value the feature must equal, be greater than, be less than, or two values the feature must be between, etc.) and a value limit or weight (e.g. a maximum value the feature may be assigned in generating the entity score, and/or a maximum percentage of the entity score the feature may comprise). For example, the entity data 112 may contain features 114 including employee count data, web traffic data, and entity financial data. Continuing with the previous example, the rule 116 may define that the employee count data must have a six month change value greater than fifty, the value threshold, (e.g., the entity must have gained or lost at least fifty employees over a six month period to count) and that the employee count data may account for a maximum of one third of the final entity score 118 (e.g., thirty-three percent of a total of one hundred points) if the threshold value is met or the employee count data may account for only ten percent of the final entity score 118 (e.g., ten percent of a total of one hundred points) if the threshold value is not met. The rule 116 may define the web traffic data must have a minimum value of one hundred, the value threshold, (e.g., a website associated with the entity must have a minimum of one hundred unique visits per day) and that the web traffic data may account for one third of the final entity score 118 if the threshold value is met or only twenty percent of the final entity score 118 if the threshold value is not met. The rule 116 may define that the entity financial data must have a value between one and five million, the threshold value (e.g. the entity must have an increase in revenue from the previous year of between one and five million dollars), and that the entity financial data may account for one third of the final entity score 118 if the value threshold is met or only twenty-five percent of the final entity score 118 if the value threshold is not met. The rules 116 may not use every feature category of the entity data 112 and the rules 116 may assign a value of zero for those features 114 not used. The rules may also include a feature category maximum defining a maximum value or percentage a single feature category can contribute to an entity score 118. For example, employment data may be limited to twenty-five percent of the total entity score 118, company fundamental data may be limited to twenty-five percent of the total entity score 118, web traffic data may be limited to twenty-five percent of the total entity score 118, entity management data may be limited to ten percent of the total entity score 118, and all other entity data may be limited to fifteen percent of the total entity score 118. The feature category limits thus limit the overall contribution of individual features to the entity. For example, if there 100 points available from employment related features specified in a rule, the maximum contribution of all of those employment related features will be limited to 25; thus the total contribution of employment related features do not overweight the entity score 118 (e.g., due to having more features from one feature category as compared to another feature category). In an exemplary embodiment, the rules 116 enable the investment scoring and ranking program 120 to generate an accurate and useful entity score 118 to be output as the investment score and rank output 154 for entities of varying sizes in varying stages of existence. For example, the rules 116 enable the investment scoring and ranking program 120 to generate a lower investment score and rank 154 output (e.g. the entity score 118) for a company of two people with a growth rate of one hundred percent compared to a company of one thousand people having a growth rate of fifty percent (e.g. a growth of two employees vs. a growth of five hundred employees). The rules 116 and the rule parameters may be generated by the computing device 102 using machine learning (e.g., each of the rule 116 may be a machine learning algorithm trained on entity data 112 of a plurality of known entities). For example, the rules 116 may be generated based on entity data 112 of known successful entities in the same field (e.g., financial services, insurance, retail, real estate, technology, etc.). Thus, the rules 116 can then take entity data 112 of a new, unknown entity (e.g., a new start-up company or private company, etc.) as input and generate an investment score and rank output 154 (e.g., the entity score 118) indicating how likely the new, unknown entity is to be successful (e.g., a high score indicating a high likelihood of success with a high investment recommendation or a low score indicating a low likelihood of success with a low investment recommendation, etc.). The investment scoring and ranking program 120 may periodically evaluate the rules 116 automatically and/or on-demand (e.g., in response to user input via the graphical user interface 152). The investment scoring and ranking program 120 may use a scoring model virtual dataset to evaluate the rule 116 against all necessary raw data (e.g. the entity data 112) required to evaluate the features 114 used by the rules 116.

The investment scoring and ranking program 120 is a software component that utilizes the entity data 142 received from the computing device 140 and/or the entity data 112 stored in the storage 110 to generate the investment score and rank output 154 (e.g., the entity score 118). In an exemplary embodiment, the investment scoring and ranking program 120 includes, a data request module 122, a data receipt module 124, a feature extraction module 126, a rule generation module 128, a data receipt module 126, a data analysis module 130, and an investment scoring and ranking output module 132. The investment scoring and ranking program 120 is a software component specifically programmed to implement the methods and functions disclosed herein for generating the investment score and ranking. The investment scoring and ranking program 120 and the modules 122-132 are discussed in more detail below with reference to FIGS. 2A, 2B, and 3.

The investment scoring and ranking program 120 can include a graphical user interface 152. The graphical user interface 152 can include components used to receive input from the computing device 102, the computing device 140, and/or the display device 150 and transmit the input to the investment scoring and ranking program 120 or conversely to receive information from the investment scoring and ranking program 120 and display the information on the computing device 102, and/or the display device 150. In an example embodiment, the graphical user interface 152 uses a combination of technologies and devices, such as device drivers, to provide a platform to enable users of the computing device 102, and/or the display device 150 to interact with the investment scoring and ranking program 120. In the example embodiment, the graphical user interface 152 receives input from a physical input device, such as a keyboard, mouse, touchpad, touchscreen, camera, microphone, etc. In an exemplary embodiment, the graphical user interface 152 may display an investment score and rank output 154 (e.g., the entity score 118). While the graphical user interface 152 is illustrated as part of the display device 150, it can be appreciated that the graphical user interface 152 is a part of the investment scoring and ranking program 120 and may be a part of the computing device 102, and/or the display device 150.

While the processor 104, the memory 108, the storage 110, and the investment scoring and ranking program 120 are illustrated as part of the computing device 102, it can be appreciated that each of these elements or a combination thereof can be a part of a separate computing device.

The computing device 140 may be a desktop computer, a notebook, a laptop computer, a tablet computer, a handheld device, a smart-phone, a thin client, or any other electronic device or computing system capable of storing, compiling, and organizing audio, visual, or textual data and receiving and transmitting that data to and from other computing devices, such as the computing device 102, and/or the display device 150. For example, the computer system 400 illustrated in FIG. 4 and discussed in more detail below may be a suitable configuration of the computing device 140. In an exemplary embodiment, the computing device 140 is the source of the entity data 112. For example, the computing device 140 may be a store of entity data 112 such as, but not limited to, SAP, social media websites, web traffic analytic web sites, news web sites, census data, etc. While only a single computing device 140 is illustrated in FIG. 1, it can be appreciated that any number of computing devices 140 may be a part of the system 100.

The display device 150 can include the graphical user interface 152. The display device 150 be any computing device, such as, but not limited to, a cell phone, a server computer, a desktop computer, a notebook, a laptop computer, a tablet computer, a handheld device, a smart-phone, a thin client, or any other electronic device or computing system capable of receiving display signals from another computing device, such as the computing device 102, and/or the computing device 140, etc. and outputting those display signals to a display unit such as, but not limited to, an LCD screen, plasma screen, LED screen, DLP screen, CRT screen, etc. For example, the graphical user interface 152 may receive the investment score and rank output 154 from the investment scoring and ranking program 120 and display the investment score and rank output 154 on the display device 150. Further, the graphical user interface 152 may receive data, e.g., the entity data 142 and/or the entity data 112, from a user and transmit that data, e.g., the entity data 142 and/or the entity data 112, to the investment scoring and ranking program 120. The data input files e.g., entity data 142 and/or the entity data 112, can include a single piece of data (e.g., a single piece of information regarding an entity from the computing device 140) or multiple pieces of data (e.g., a plurality of a pieces of information regarding an entity from the computing device 140). The display device 150 may communicate with the computing device 102, and/or the computing device 140 via a hard-wired connection or via the network 160. For example, the display device 150 may have a hard-wired connection to the image device such as, but not limited to, a USB connection, an HDMI connection, a display port connection, a VGA connection, or any other known hard-wired connection capable of transmitting and/or receiving data between the computing device 102, the computing device 140, and/or the display device 150.

While the display device 150 is illustrated as being separate from the computing device 102, and the computing device 140, it can be appreciated that the display device 150 can be a part of the computing device 102, and/or the computing device 140. For example, the computer system 400 illustrated in FIG. 4 and discussed in more detail below may be a suitable configuration of the computing device 102, the computing device 140, and/or the display device 150.

The optional network 160 may be any network suitable for performing the functions as disclosed herein and may include a local area network (LAN), a wide area network (WAN), a wireless network (e.g., WiFi), a personal area network (PAN) (e.g. Bluetooth), a near-field communication (NFC) network, a mobile communication network, a satellite network, the Internet, fiber optic, coaxial cable, other hardwired networks, infrared, radio frequency (RF), or any combination of the foregoing. Other suitable network types and configurations will be apparent to persons having skill in the relevant art. In general, the network 160 can be any combination of connections and protocols that will support communications between the computing device 102, the computing device 140, and/or the display device 150. In some embodiments, the network 160 may be optional based on the configuration of the computing device 102, the computing device 140, and the display device 150.

### Exemplary Process for Investment Scoring and Ranking

FIGS. 2A-2B illustrates a process for investment scoring and ranking in the system 100 of FIG. 1.

In step 202, the computing device 102 generates a request for entity data 112 from the computing device 140. The request may be generated automatically by the investment scoring and ranking program 120 or generated by user input via the graphical user interface 152. The computing device 102 may request any data regarding a specific entity or a plurality of specific entities. The entity data 112 requested by the computing device 102 may be any data related to the one or more specific entities or for specific data related to the one or more specific entities. For example, the computing device 102 may already have entity data 112 regarding a specific entity and the request may be for updated data (e.g., any data that has changed or been added since the last request for entity data 112 related to that specific entity), or for a specific type of data (e.g., employment data, web traffic data, entity financial data, etc.), etc. In an exemplary embodiment, the data request module 122 of the investment scoring and ranking program 120 can be configured to execute step 202.

In step 204, the computing device 102 transmits the request for entity data 112 to the computing device 140. The request may be transmitted to the computing device 140 using any suitable communication method (e.g., the network 160). In an exemplary embodiment, the data request module 122 of the investment scoring and ranking program 120 can be configured to execute step 204.

In step 206, the computing device 140 receives the request for entity data 112 from the computing device 102 and in step 208, the computing device 140 compiles the requested entity data 112. The computing device 140 may search a local or remote database for the entity data or in turn may submit a request to a third computing device for the entity data 112. For example, the computing device 140 may be a social media server and the computing device 140 compiles all social media data regarding the specific one or more entities in the request from servers associated with the social media company or the computing device may have access to one or more third-party resources that contains data regarding the specific one or more entities in the request and the computing device 140 compiles that data from the one or more third-party resources.

In step 210, the computing device 140 transmits the entity data 112 to the computing device 102. The entity data 112 may be transmitted to the computing device 102 using any suitable communication method (e.g., the network 160).

In step 212, the computing device 102 receives the entity data 112 from the computing device 140 and stores the entity data 112 in the storage 110 in step 214. In an exemplary embodiment, the data receipt module 124 of the investment scoring and ranking program 120 can be configured to execute steps 212 and 214.

In step 216, the computing device 102 extracts one or more features 114 from the entity data 112. For example, the entity data 112 may include a monthly employee count for a specific entity such as a first quarter of 2021 employee count of one hundred and a first quarter of 2022 employee count of two hundred and the computing device 102 can generate a feature 114 of a one year increase of one hundred employees or a 100% employee growth rate for the specific entity. In an exemplary embodiment, the feature extraction module 126 of the investment scoring and ranking program 120 can be configured to execute step 216.

In step 218, the computing device 102 generates one or more rules 116 based on the entity data 112. Continuing with the previous example, the rule 116 may define that the employee count data must have a one year change value greater than fifty, the value threshold, (e.g., the entity must have gained or lost at least fifty employees over a one year period to count) and that the employee count data may account for a maximum of one third of the final entity score (e.g., thirty-three percent of a total of one hundred points) if the threshold value is met or the employee count data may account for only ten percent of the final entity score (e.g., ten percent of a total of one hundred points) if the threshold value is not met. In an exemplary embodiment, the rule generation module 126 of the investment scoring and ranking program 120 can be configured to execute step 218.

In step 220, the computing device 102 generates a new request for new entity data 112. The new request may be generated automatically by the investment scoring and ranking program 120 or generated by user input via the graphical user interface 152. The computing device 102 may request entity data 112 regarding a new entity or a plurality of new entities to be scored and ranked by the investment scoring and ranking program 120. For example, a new start-up company may be identified for analysis by a user of the investment scoring and ranking program 120. In another example, the investment scoring and ranking program 120 may be scheduled to automatically collect new entity data 112 for all entities related to the entity data 112 stored in the storage 110 at periodic intervals (e.g., every week, every month, every year, etc.). In an exemplary embodiment, the data request module 122 of the investment scoring and ranking program 120 can be configured to execute step 220.

In step 222, the computing device 102 transmits the new request for new entity data 112 to the computing device 140. The new request may be transmitted to the computing device 140 using any suitable communication method (e.g., the network 160). In an exemplary embodiment, the data request module 122 of the investment scoring and ranking program 120 can be configured to execute step 204.

In step 224, the computing device 140 receives the new request for new entity data 112 from the computing device 102 and in step 226, the computing device 140 compiles the requested new entity data 112. The computing device 140 may search a local or remote database for the new entity data 112 or in turn may submit a request to a third computing device for the new entity data 112.

In step 228, the computing device 140 transmits the new entity data 112 to the computing device 102. The new entity data 112 may be transmitted to the computing device 102 using any suitable communication method (e.g., the network 160).

In step 230, the computing device 102 receives the new entity data 112 from the computing device 140 and stores the new entity data 112 in the storage 110 in step 232. In an exemplary embodiment, the data receipt module 124 of the investment scoring and ranking program 120 can be configured to execute steps 230 and 232.

In step 234, the computing device 102 extracts one or more features 114 from the new entity data 112 and applies the one or more rules 116 to the one or more features 114 of the new entity data 112 in step 236.

In step 238, the computing device 102 generates a report illustrating the investment score and rank output 154 (e.g., the entity score 118) of the new entity and transmits the investment score and rank output 154 to the display device 150 via the user interface 152 in step 240. The report illustrating the investment score and rank output 154 may be transmitted to the display device 150 using any suitable communication method (e.g., the network 160). In an exemplary embodiment, investment scoring and ranking output module 132 of the investment scoring and ranking program 120 can be configured to execute step 238.

In step 242, the display device 150 receives the report illustrating the investment score and rank 154 (e.g., the entity score 118) for the new entity and displays the report illustrating the investment score and rank 154 via the graphical user interface 152.

### Exemplary Method for Investment Scoring and Ranking

FIG. 3 illustrates a method 300 for investment scoring and ranking in accordance with exemplary embodiments.

The method 300 can include block 302 of storing, in a memory (e.g., the storage 110) of a processing device (e.g., the computing device 102), data and an investment score of one or more entities (e.g., the entity data 112). In an exemplary embodiment, data receipt module 124 of the investment scoring and ranking program 120 can be configured to execute the method of block 302.

The method 300 can include block 304 of extracting, by the processing device (e.g., the computing device 102), one or more features (e.g., the features 114) from the data (e.g. the entity data 112). The one or more features may be stored by the computing device 102 as virtual datasets. The processing device classifies each of the one or more features of the data into one or more feature categories. In an exemplary embodiment, feature extraction module 126 of the investment scoring and ranking program 120 can be configured to execute the method of block 304.

The method 300 can include block 306 of generating, by the processing device (e.g., the computing device 102), one or more rules (e.g. the rules 116). The one or more rules include one or more records and each of the one or more records correspond to a feature (e.g. a feature 114) and define at least a weight for the corresponding feature such that each feature represents a maximum percentage of the entity score 118. The one or more rules are generated by a machine learning model that is trained using the data (e.g., the entity data 112) and the investment score of the one or more entities. The weight of the one or more features is based on the feature category such that each feature category represents a maximum percentage of the score. Further, wherein the one or more records for each of the one or more features define a value range for the feature. In an exemplary embodiment, rule generation module 128 of the investment scoring and ranking program 120 can be configured to execute the method of block 306.

The method 300 can include block 308 of receiving data (e.g. entity data 112) regarding a new entity by the processing device (e.g. the computing device 102). In an exemplary embodiment, data receipt module 124 of the investment scoring and ranking program 120 can be configured to execute the method of block 308.

The method 300 can include block 310 of extracting, by the processing device (e.g. the computing device 102), one or more features (e.g. the features 114) from the data (e.g. the entity data 112) regarding the new entity. In an exemplary embodiment, feature extraction module 126 of the investment scoring and ranking program 120 can be configured to execute the method of block 310.

The method 300 can include block 312 of applying, by the processing device (e.g. the computing device 102), the one or more rules (e.g. the rules 116) corresponding to the one or more features (e.g. the features 114) of the data (e.g. the entity data 112) regarding the new entity. The processing device may determine a value for each of the one or more extracted features of the new entity and apply the one or more rules to each extracted feature of the new entity within the value range. In an exemplary embodiment, data analysis module 130 of the investment scoring and ranking program 120 can be configured to execute the method of block 312.

The method 300 can include block 314 of outputting, by the processing device (e.g. the computing device 102), a new investment score (e.g. the investment score and rank output 154 including the entity score 118) for the new entity based on the one or more rules (e.g. the rules 116). The new investment score indicates an investment potential of the new entity. Outputting the new investment score may include generating a report illustrating the new investment score of the new entity in relation to the investment score of the one or more entities. In an exemplary embodiment, the investment score and rank output module 132 of the investment scoring and ranking program 120 can be configured to execute the method of block 312.

### Computer System Architecture

FIG. 4 illustrates a computer system 400 in which embodiments of the present disclosure, or portions thereof, may be implemented as computer-readable code. For example, the computing device 102, the computing device 140, and/or the display device 150 of FIG. 1 may be implemented in the computer system 400 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 2A, 2B, and 3.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 418, a removable storage unit 422, and a hard disk installed in hard disk drive 412.

Various embodiments of the present disclosure are described in terms of this example computer system 400. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 404 may be a special purpose or a general purpose processor device specifically configured to perform the functions discussed herein. The processor device 404 may be connected to a communications infrastructure 406, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 400 may also include a main memory 408 (e.g., random access memory, read-only memory, etc.), and may also include a secondary memory 410. The secondary memory 410 may include the hard disk drive 412 and a removable storage drive 414, such as a floppy disk drive, a magnetic tape drive, an optical disk drive, a flash memory, etc.

The removable storage drive 414 may read from and/or write to the removable storage unit 418 in a well-known manner. The removable storage unit 418 may include a removable storage media that may be read by and written to by the removable storage drive 414. For example, if the removable storage drive 414 is a floppy disk drive or universal serial bus port, the removable storage unit 418 may be a floppy disk or portable flash drive, respectively. In one embodiment, the removable storage unit 418 may be non-transitory computer readable recording media.

In some embodiments, the secondary memory 410 may include alternative means for allowing computer programs or other instructions to be loaded into the computer system 400, for example, the removable storage unit 422 and an interface 420. Examples of such means may include a program cartridge and cartridge interface (e.g., as found in video game systems), a removable memory chip (e.g., EEPROM, PROM, etc.) and associated socket, and other removable storage units 422 and interfaces 420 as will be apparent to persons having skill in the relevant art.

Data stored in the computer system 400 (e.g., in the main memory 408 and/or the secondary memory 410) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 400 may also include a communications interface 424. The communications interface 424 may be configured to allow software and data to be transferred between the computer system 400 and external devices. Exemplary communications interfaces 424 may include a modem, a network interface (e.g., an Ethernet card), a communications port, a PCMCIA slot and card, etc. Software and data transferred via the communications interface 424 may be in the form of signals, which may be electronic, electromagnetic, optical, or other signals as will be apparent to persons having skill in the relevant art. The signals may travel via a communications path 426, which may be configured to carry the signals and may be implemented using wire, cable, fiber optics, a phone line, a cellular phone link, a radio frequency link, etc.

The computer system 400 may further include a display interface 402. The display interface 402 may be configured to allow data to be transferred between the computer system 400 and external display 430. Exemplary display interfaces 402 may include high-definition multimedia interface (HDMI), digital visual interface (DVI), video graphics array (VGA), etc. The display 430 may be any suitable type of display for displaying data transmitted via the display interface 402 of the computer system 400, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 408 and secondary memory 410, which may be memory semiconductors (e.g., DRAMs, etc.). These computer program products may be means for providing software to the computer system 400. Computer programs (e.g., computer control logic) may be stored in the main memory 408 and/or the secondary memory 410. Computer programs may also be received via the communications interface 424. Such computer programs, when executed, may enable computer system 400 to implement the present methods as discussed herein. In particular, the computer programs, when executed, may enable processor device 404 to implement the processes and methods illustrated by FIGS. 2A, 2B, and 3, as discussed herein. Accordingly, such computer programs may represent controllers of the computer system 400. Where the present disclosure is implemented using software, the software may be stored in a computer program product and loaded into the computer system 400 using the removable storage drive 414, interface 420, and hard disk drive 412, or communications interface 424.

The processor device 404 may comprise one or more modules or engines configured to perform the functions of the computer system 400. Each of the modules or engines may be implemented using hardware and, in some instances, may also utilize software, such as corresponding to program code and/or programs stored in the main memory 408 or secondary memory 410. In such instances, program code may be compiled by the processor device 404 (e.g., by a compiling module or engine) prior to execution by the hardware of the computer system 400. For example, the program code may be source code written in a programming language that is translated into a lower level language, such as assembly language or machine code, for execution by the processor device 404 and/or any additional hardware components of the computer system 400. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 400 to perform the functions disclosed herein. It will be apparent to persons having skill in the relevant art that such processes result in the computer system 400 being a specially configured computer system 400 uniquely programmed to perform the functions discussed above.

Techniques consistent with the present disclosure provide, among other features, systems and methods for scoring and ranking entities for investment. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter. It will be appreciated by those skilled in the art that the present disclosure can be embodied in other specific forms without departing from the spirit or essential characteristics thereof. The presently disclosed embodiments are therefore considered in all respects to be illustrative and not restrictive. The scope of the disclosure is indicated by the appended claims rather than the foregoing description, and all changes that come within the meaning, range, and equivalence thereof are intended to be embraced therein.

What is claimed is:

1. A method for investment scoring and ranking, the method comprising:
storing, in a memory of a processing device, data and an investment score of one or more entities;
extracting, by the processing device, one or more features from the data;
generating, by the processing device, one or more rules, the one or more rules including one or more records, each of the one or more records corresponding to a feature and each of the one or more records defining at least a weight for the corresponding feature such that each feature represents a maximum percentage of a score;
receiving data regarding a new entity;
extracting, by the processing device, one or more features from the data regarding the new entity;
applying, by the processing device, the one or more rules corresponding to the one or more features of the data regarding the new entity; and
outputting, by the processing device, a new investment score for the new entity based on the one or more rules, the new investment score indicating an investment potential of the new entity.

2. The method of claim 1, wherein the one or more rules are generated by a machine learning model, the machine learning model trained using the data and the investment score of the one or more entities.

3. The method of claim 1, wherein the one or more records for each of the one or more features defines a value range for the feature, wherein the applying the one or more rules includes;
determining, by the processing device, a value for each of the one or more extracted features of the new entity; and
applying, by the processing device, the one or more rules to each extracted feature of the new entity within the value range.

4. The method of claim 1, comprising:
classifying, by the processing device, the one or more features of the data into one or more feature categories; and
wherein the weight of the one or more features is based on the feature category such that each feature category represents a maximum percentage of the score.

5. The method of claim 1, wherein the one or more features are implemented as virtual datasets.

6. The method of claim 1, wherein the outputting, by the processing device, the new investment score for the new entity includes:
generating, by the processing device, a report illustrating the new investment score of the new entity in relation to the investment score of the one or more entities.

7. A system for investment scoring and ranking, the system comprising:
one or more processors, one or more computer-readable memories, one or more computer-readable tangible storage devices, and instructions stored on at least one of the one or more storage devices for execution by at least one of the one or more processors via at least one of the one or more computer-readable memories, the instructions comprising:
instructions to store data and an investment score of one or more entities;
instructions to extract one or more features from the data;
instructions to generate one or more rules, the one or more rules including one or more records, each of the one or more records corresponding to a feature and each of the one or more records defining at least a weight for the corresponding feature such that each feature represents a maximum percentage of a score;
instructions to receive data regarding a new entity;
instructions to extract one or more features from the data regarding the new entity;
instructions to apply the one or more rules corresponding to the one or more features of the data regarding the new entity; and
instructions to output a new investment score for the new entity based on the one or more rules, the new investment score indicating an investment potential of the new entity.

8. The system of claim 7, wherein the one or more rules are generated by a machine learning model, the machine learning model trained using the data and the investment score of the one or more entities.

9. The system of claim 7, wherein the one or more records for each of the one or more features defines a value range for the feature, wherein the applying the one or more rules includes:
instructions to determine a value for each of the one or more extracted features of the new entity; and
instructions to apply the one or more rules to each extracted feature of the new entity within the value range.

10. The system of claim 7, comprising:
instructions to classify the one or more features of the data into one or more feature categories; and
wherein the weight of the one or more features is based on the feature category such that each feature category represents a maximum percentage of the score.

11. The system of claim 7, wherein the one or more features are implemented as virtual datasets.

12. The system of claim 7, wherein the outputting, by the processing device, the new investment score for the new entity includes:
instructions to generate a report illustrating the new investment score of the new entity in relation to the investment score of the one or more entities.

13. A computer program product for investment scoring and ranking, the computer program product comprising:
a computer-readable storage medium having program instructions embodied therewith, the program instructions executable by a computer to cause the computer to perform a method, comprising:
storing, in a memory of a processing device, data and an investment score of one or more entities;
extracting, by the processing device, one or more features from the data;
generating, by the processing device, one or more rules, the one or more rules including one or more records, each of the one or more records corresponding to a feature and each of the one or more records defining at least a weight for the corresponding feature such that each feature represents a maximum percentage of a score;
receiving data regarding a new entity;
extracting, by the processing device, one or more features from the data regarding the new entity;
applying, by the processing device, the one or more rules corresponding to the one or more features of the data regarding the new entity; and
outputting, by the processing device, a new investment score for the new entity based on the one or more rules, the new investment score indicating an investment potential of the new entity.

14. The computer program product of claim 13, wherein the one or more rules are generated by a machine learning model, the machine learning model trained using the data and the investment score of the one or more entities.

15. The computer program product of claim 13, wherein the one or more records for each of the one or more features defines a value range for the feature, wherein the applying the one or more rules includes;
determining, by the processing device, a value for each of the one or more extracted features of the new entity; and
applying, by the processing device, the one or more rules to each extracted feature of the new entity within the value range.

16. The computer program product of claim 13, comprising:
classifying, by the processing device, the one or more features of the data into one or more feature categories; and
wherein the weight of the one or more features is based on the feature category such that each feature category represents a maximum percentage of the score.

17. The computer program product of claim 13, wherein the one or more features are implemented as virtual datasets.

18. The computer program product of claim 13, wherein the outputting, by the processing device, the new investment score for the new entity includes:
generating, by the processing device, a report illustrating the new investment score of the new entity in relation to the investment score of the one or more entities.
